(19) United States
(12) Patent Application Publication
(10) Pub. No.: US 2025/0091385 A1
(43) Pub. Date: Mar. 20, 2025

(54) MOVING DEVICE

(71) Applicant: Positec Power Tools (Suzhou) Co., Ltd., Suzhou (CN)

(72) Inventors: Fan Yang, Suzhou (CN); Shisong Zhang, Suzhou (CN); Hongfeng Zhong, Suzhou (CN); Hongda Qi, Suzhou (CN)

(21) Appl. No.: 18/369,572

(22) Filed: Sep. 18, 2023

(51) Int. Cl. B60B 21/10; B60C 7/24

(52) U.S. Cl. CPC B60B 21/10; B60C 7/24

(57) ABSTRACT

The present disclosure relates to a moving device, including a body and wheels arranged at a bottom of the body to drive the moving device to move. The wheel includes: a rim; and a tire. The tire is detachably connected to the rim, and includes a first end and a second end detachably butt-joined, such that the tire can be disconnected at the first end and the second end to allow the tire to be detached relative to the rim. When the tire is damaged and needs to be replaced, the tire is disconnected at the first end and the second end so as to be gradually separated from the rim, and thus, a user can replace the tire without detaching any part of the body.

### TECHNICAL FIELD

The present disclosure relates to a moving device, and more particularly to a moving device moving on a surface of a working region.

### BACKGROUND

A wheel of a moving device typically includes a rim and a tire. In order to maximize the rigidity of the wheel, the rim and the tire are usually integrated. When the tire experiences a malfunction or damage, due to difficult separation of the rim and the tire, a user has to replace the rim and the tire together when replacing the tire, and meanwhile, replacement and assembly operations are extremely complex, which brings troubles to the user and also increases the economic burden of the user. Thus, a detachable wheel is manufactured. However, in the related technology, when the tire of the wheel of the moving device needs to be replaced, the entire wheel is usually required to be disassembled from the moving device, such that the tire and the rim can be disassembled, and this process is inconvenient and complex.

In response to the above requirements, some tires in the related technology can be designed to be detachably connected to the rim. However, after the wheel is installed on the moving device, the wheel is usually partially located inside a body to reduce the height, consequently, it is still necessary to partially dismount the body for dismounting the tire from the rim, so that independent tire replacement is troublesome, and even the user is unable to independently replace the tire.

### SUMMARY OF THE INVENTION

In view of this, an objective of the present disclosure is to provide a moving device, which facilitates independent tire replacement.

A moving device includes a body and wheels arranged at a bottom of the body to drive the moving device to move. The wheel includes: a rim; and a tire, where the tire is detachably connected to the rim, and includes a first end and a second end. The first end and the second end are detachably connected, such that the first end and the second end can be disconnected to allow the tire to be detached relative to the rim.

According to the above moving device, when the tire is damaged and needs to be replaced, by rotating the wheel, the first end and the second end are rotated to face away from one side of the body, then the tire is disconnected at the first end and the second end so as to be gradually separated from the rim, and thus, a user can independently replace the tire without detaching any part of the body.

In an exemplary embodiment, the first end abuts against the second end in a circumferential direction of the wheel.

In an exemplary embodiment, the first end and the second end are arranged in an overlapping manner.

In an exemplary embodiment, the tire includes a plurality of segments of assembly parts sequentially connected in an end-to-end manner.

In an exemplary embodiment, the number of the segments of the assembly parts of the tire is less than or equal to 3.

In an exemplary embodiment, the tire and the rim are detachably connected through a tongue-and-groove engagement mechanism.

In an exemplary embodiment, the wheel is provided with a first limiting mechanism configured to limit the relative movement of the rim and the tire in the circumferential direction of the wheel.

In an exemplary embodiment, the first limiting mechanism includes a first limiting structure arranged on the rim, and a second limiting structure arranged on the tire and configured to engage with the first limiting structure; or, the first limiting mechanism is arranged on at least one of the rim and the tire.

In an exemplary embodiment, the first limiting mechanism includes a protrusion and a groove configured to engage with each other. One of the protrusion and the groove is arranged on the rim, and the other one of the protrusion and the groove is arranged on the tire.

In an exemplary embodiment, the wheel is provided with a second limiting mechanism configured to limit the relative movement of the rim and the tire in an axial direction of the wheel.

In an exemplary embodiment, the second limiting mechanism includes a first stop structure arranged on the rim, and a second stop structure arranged on the tire and configured to engage with the first stop structure; or, the second limiting mechanism is arranged on at least one of the rim and the tire.

In an exemplary embodiment, the tire is elastic.

In an exemplary embodiment, the body includes a housing arranged on an outer side of the wheel; and in a projection plane perpendicular to the axial direction of the wheel, a projection contour of the housing partially overlaps with a projection contour of the wheel.

In an exemplary embodiment, in the axial direction of the wheel, a distance between the housing and an outer side of the wheel is smaller than a width of the wheel in the axial direction of the wheel.

In an exemplary embodiment, the wheel is provided with a locking mechanism. The locking mechanism is configured to fix the tire and the rim in at least one direction. The at least one direction includes at least one of the following: the axial direction, a radial direction and the circumferential direction of the wheel.

In an exemplary embodiment, the locking mechanism is configured to fix the tire and the rim together at least in the radial direction of the wheel.

In an exemplary embodiment, the rim is provided with a fixing portion, the tire is provided with a connecting portion, and the connecting portion and the fixing portion are adaptively connected; or, the connecting portion is detachably connected to the fixing portion through a fixing component.

In an exemplary embodiment, the fixing portion is arranged on an inner circumferential surface of the rim, and an engagement portion configured to engage with the tire and evenly distributed in the circumferential direction of the wheel is formed on an outer circumferential surface of the rim.

In an exemplary embodiment, the fixing component is a buckle.

In an exemplary embodiment, the moving device is a self-moving device, and the self-moving device includes a robot cleaner.

### BRIEF DESCRIPTION OF THE DRAWINGS

The accompanying drawings constituting a part of this application are used to provide a further understanding of the present disclosure. The exemplary embodiments of the present disclosure and descriptions thereof are used to explain the present disclosure, and do not constitute improper limitations on the present disclosure.

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without paying creative efforts.

FIG. 1 is a schematic structural diagram of a moving device according to an embodiment of the present disclosure;

FIG. 2 is a simplified schematic structural diagram of a rim according to an embodiment of the present disclosure;

FIG. 3 is a simplified schematic structural diagram of a tire according to an embodiment of the present disclosure;

FIG. 4 is a simplified assembly diagram of a wheel according to an embodiment of the present disclosure;

FIG. 5 is an exploded view of a wheel according to an embodiment of the present disclosure;

FIG. 6 is a three-dimensional diagram of a wheel according to an embodiment of the present disclosure;

FIG. 7 is a partial section view in an A-A direction in FIG. 6;

FIG. 8 is a schematic diagram of an assembly manner of a rim and a tire of a wheel according to an embodiment of the present disclosure;

FIG. 9 is a front view of a wheel according to an embodiment of the present disclosure;

FIG. 10 is a side view of a wheel according to an embodiment of the present disclosure;

FIG. 11 is a structural diagram of a tire of a wheel according to another embodiment of the present disclosure;

FIG. 12 is a partial section view in a B-B direction in FIG. 11;

FIG. 13 is a schematic structural diagram of a rim of a wheel according to another embodiment of the present disclosure;

FIG. 14 is an assembly diagram of a wheel according to another embodiment of the present disclosure;

FIG. 15 is a front view of the wheel shown in FIG. 14;

FIG. 16 is a section view in a C-C direction in FIG. 15;

FIG. 17 is a schematic structural diagram of a tire of a wheel according to another embodiment of the present disclosure;

FIG. 18 is a section view in a D-D direction in FIG. 17;

FIG. 19 is a schematic diagram of an assembly manner of a rim and a tire of a wheel according to another embodiment of the present disclosure;

FIG. 20 is an assembly diagram of a wheel according to another embodiment of the present disclosure;

FIG. 21 is a front view of a wheel according to another embodiment of the present disclosure;

FIG. 22 is an assembly diagram of a wheel according to another embodiment of the present disclosure;

FIG. 23 is a partial section view in an E-E direction in FIG. 22;

FIG. 24 is an exploded view of a wheel according to another embodiment of the present disclosure;

FIG. 25 is a schematic structural diagram of a tire of a wheel according to another embodiment of the present disclosure;

FIG. 26 is an assembly diagram of a wheel from another angle according to another embodiment of the present disclosure;

FIG. 27 is a front view of a tire of a wheel according to another embodiment of the present disclosure;

FIG. 28 is a side view of a tire of a wheel according to another embodiment of the present disclosure;

FIG. 29 is a side view of a rim of a wheel according to another embodiment of the present disclosure;

FIG. 30 is a partial section view in an F-F direction in FIG. 29;

FIG. 31 is a schematic diagram of an assembly manner of a rim and a tire of a wheel according to another embodiment of the present disclosure;

FIG. 32 is a partial section view of an assembled rim and a tire of a wheel according to another embodiment of the present disclosure;

FIG. 33 is an exploded view of a wheel according to another embodiment of the present disclosure;

FIG. 34 is an assembly diagram of a wheel according to another embodiment of the present disclosure;

FIG. 35 is a section view in a G-G direction in FIG. 34; and

FIG. 36 is a schematic diagram of an assembly manner of a rim and a tire of a wheel according to another embodiment of the present disclosure.

### CORRESPONDING REFERENCE NUMERALS OF RELATED COMPONENTS IN THE FIGURES ARE AS BELOW

1-moving device; 11-body; 111-housing; 12-wheel set; 13-front wheel; 14-driving rear wheel; 100-wheel; 10-rim; 101-series component; 110-outer circumferential surface; 120-fixing portion; 121-fixing column; 122-fixing hole; 123-plug-in component; 124-fixing groove; 20-tire; 210-first end; 212-first connecting region; 213-second connecting region; 220-second end; 221-third connecting region; 222-fourth connecting region; 223-connecting screw; 230-joint; 240-connecting portion; 241-groove segment; 242-clamping segment; 243-first connecting portion; 244-second connecting portion; 250-connecting hole; 251-first part; 252-second part; 253-first step; 30-wheel axle; 40-fixing component; 410-screw; 420-long locking end; 430-short locking end; 611-first limiting structure; 621-second limiting structure; 612-first stop structure; 622-second stop structure; 630-first plug-in structure; 631-clamping component; 632-stop portion; 640-second plug-in structure; 641-slot; 642-second step; and 70-third stop structure.

### DETAILED DESCRIPTION

To make the above objectives, features, and advantages of the present disclosure more apparent and understandable, specific implementations of the present disclosure will be described in detail below in conjunction with accompanying drawings. Many specific details are described below to facilitate a thorough understanding of the present disclosure. However, the present disclosure can be implemented in many other ways different from those described herein. Those skilled in the art may make similar improvements without departing from the intention of the present disclosure. Therefore, the present disclosure is not limited to the specific embodiments disclosed below.

In the description of the present disclosure, it should be understood that orientation or position relationships indicated by the terms such as “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, “clockwise”, “anticlockwise”, “axial”, “radial”, and “circumferential” are based on orientation or position relationships shown in the accompanying drawings, and are used only for conveniently describing the present disclosure and simplifying the description, rather than indicating or implying that the mentioned apparatus or component needs to have a particular orientation or needs to be constructed and operated in a particular orientation, and thus should not be understood as limitations on the present disclosure.

In addition, the terms “first” and “second” are merely with respect to a purpose of description, and shall not be understood as an indication or implication of relative importance or implicit indication of the quantity of indicated technical features. Therefore, a feature restricted by “first” or “second” may explicitly indicate or implicitly include at least one of such features. In the description of the present disclosure, “a plurality of” means at least two, such as two or three, unless otherwise explicitly limited.

In the present disclosure, unless otherwise explicitly specified and limited, the terms “mount”, “connect”, “link”, and “fix” are to be understood in a broad sense. For example, a connection may be a fixed connection, a detachable connection, or an integrated connection; or, the connection may be a mechanical connection or an electrical connection; or, the connection may be a direct connection, an indirect connection through an intermediary, or internal communication between two components, or a mutual action relationship between two components, unless otherwise specified explicitly. Those of ordinary skill in the art may understand the specific meanings of the above terms in the present disclosure according to specific situations.

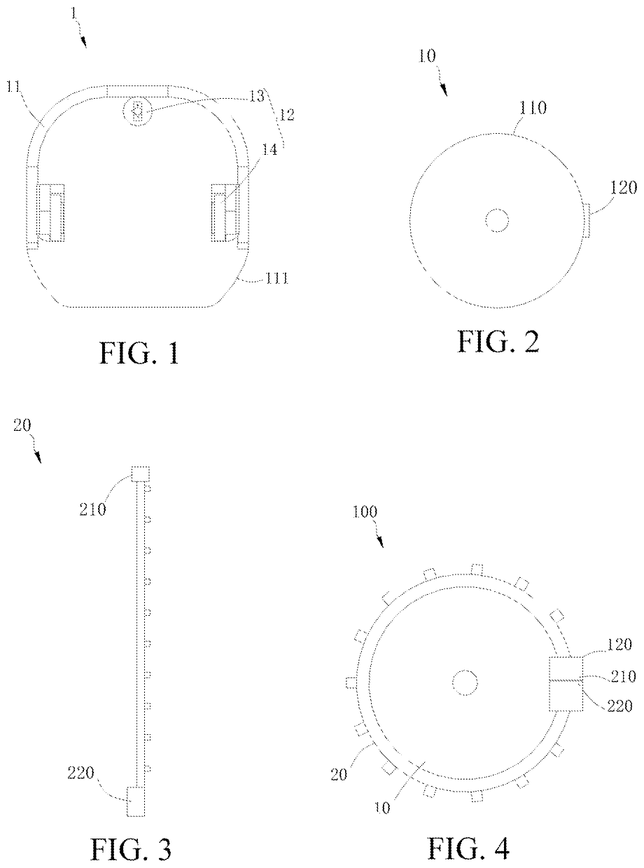

Refer to FIG. 1, the present disclosure discloses a moving device 1. In an embodiment, the moving device may be an outdoor gardening moving device, such as a smart lawnmower, a lawnmower, an automatic leaf sweeper, and a multi-functional outdoor self-moving device. Actually, the moving device 1 may also be an automatic robot, such as a cleaning robot and a home service robot, or may be another device such as a moving platform, which is not specifically limited, and may be decided according to actual situations. In this embodiment, the moving device 1 is the self-moving device such as the smart lawnmower and the cleaning robot. The self-moving device includes a body 11, a working component and a wheel set 12 on the body 11, a driving assembly arranged inside the body 11 and configured to drive the working component and the wheel set 12 to operate, a control system configured to control the driving assembly, and a power source configured to supply power to the self-moving device. The wheel set 12 includes a front wheel 13 arranged at a front portion of the body 11, and a pair of driving rear wheels 14 arranged on two sides of a rear portion of the body 11. The front wheel 13 is a universal wheel. Each of the driving rear wheels 14 is connected to an independent walking motor, such that the smart lawnmower is controlled to steer by controlling a speed difference of the two walking motors.

The two driving rear wheels 14 have consistent performance. A wheel 100 of the driving rear wheel 14 is adopted as an example for further description below. In addition, the front wheel 13 may also be the same as the driving rear wheels 14. The wheels 100 are arranged at a bottom of the body 11 to drive the moving device 1 to move. Illustratively, in order to reduce the height of the moving device 1 and make the moving device compact, a part of the wheel 100 is located inside the body 11, while the remaining part of the wheel 100 is exposed outside the body 11. The part of the wheel 100 located inside the body 11 means that: in the use state of the moving device 1, when the wheel 100 is in contact with a working surface, in a vertical direction, a part of the wheel 100 is located above a lowest point of the body 11, and this part of the wheel 100 cannot be observed from the side. When the part of the wheel 100 is located above the lowest point of the body 11, the part of the wheel 100 may be located inside a cavity in the body 11.

As shown in FIG. 1, during specific arrangement, each of the driving rear wheels 14 (the wheel 100) is located on an inner side of a housing 111 of the body. Accordingly, in a projection plane perpendicular to an axial direction of the wheel 100 (in the vertical direction perpendicular to the axial direction of the wheel 100), a projection contour of the housing 111 partially overlaps with a projection contour of the wheel 100. Thus, the moving device 1 has a compact structure. Further, in the axial direction of the wheel 100, a distance between the housing 111 and an outer side of the wheel 100 is smaller than a width of the wheel 100 in the axial direction. In this case, the size of the wheel 100 is greater than the distance between the housing 111 and the outer side of the wheel 100, which ensures good mobility of the wheel 100 and also satisfies the requirement for a compact device structure. However, the situation further results in inconvenience of disassembling the wheel 100 and greater difficulty in independent replacement of a tire of the wheel 100.

As shown in FIG. 2 to FIG. 4, the wheel 100 includes a rim 10, and a tire 20 detachably connected to the rim 10. When the tire is connected to the rim, the tire may wrap the rim. In order to allow the tire 20 to be detached from the rim 10, the tire is designed to be non-closed-loop. In other words, the tire may include two free ends detachably butt-joined. The tire 20 in various embodiments of this application includes a first end 210 and a second end 220. The first end 210 and the second end 220 are in separable butt joint, such that the tire 20 can be disconnected at the first end 210 and the second end 220, which allows the tire 20 to be detached relative to the rim 10. When the tire 20 is required to be replaced, the positions where the first end 210 and the second end 220 are located are rotated to a position facilitating operation (e.g., facing away from the body 11), making the tire 20 disconnected at the first end 210 and the second end 220, such that a user can conveniently replace the tire 20.

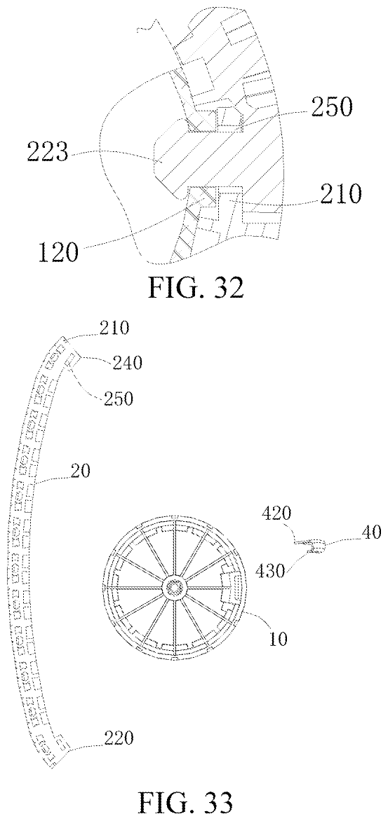

Illustratively, as shown in FIG. 3, the tire 20 is unfolded into a strip shape before being connected to the rim 10. The tire 20 includes the first end 210 and the second end 220. The first end 210 and the second end 220 are two free ends of the tire 20 in a length direction when the tire is unfolded into the strip shape. As shown in FIG. 2, an outer circumferential surface 110 of the rim 10 is provided with a fixing portion 120. As shown in FIG. 4, when the tire 20 is arranged on the outer circumferential surface 110 of the rim 10, the first end 210 abuts against the second end 220 in a circumferential direction of the wheel 100, such that the outer circumferential surface of the tire 20 is continuous, the moving performance of the wheel 100 is uniform, and the performance of the wheel 100 is not influenced. Illustratively, the first end 210 and the second end 220 may alternatively be arranged in an overlapping manner in the circumferential direction of the wheel 100, as shown in FIG. 31 and FIG. 32.

In the above embodiment, the first end 210 and the second end 220 are connected through the fixing portion 120. Moreover, the first end 210 and the second end 220 may be independently connected to the fixing portion 120, or may be connected to the fixing portion 120 after being combined into a whole. The first end 210 and the second end 220 may be detachably connected to the fixing portion 120 through a fixing component. The fixing component may be a screw or buckle. There may be one or more fixing components. The first end 210 and the second end 220 may alternatively be adaptively connected to the fixing portion 120 without using any fixing component. For example, the first end 210 and the second end 220 are each provided with a connecting portion, and the connecting portion is clamped with the fixing portion 120.

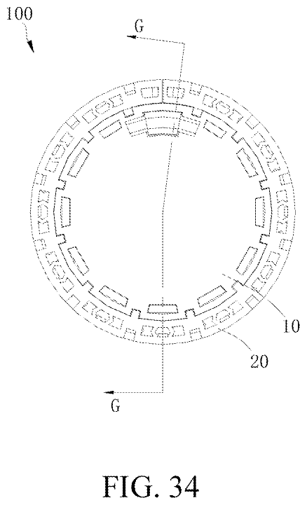

It should be noted that, when the fixing component 40 is used, that is, when the first end 210 and the second end 220 can be detachably connected to the fixing portion 120 through the fixing component, the fixing component 40 can not only fix the first end 210 and the second end 220 together but also can lock the tire and the rim by cooperating with the fixing portion 120 arranged on the rim, and thus, the fixing component 40 and the fixing portion 120 may also be referred to as wheel locking mechanisms. It should be understood that the wheel locking mechanism, such as the above fixing component 40 and the fixing portion 120, may fix the tire and the rim in at least one direction (e.g., the axial direction, radial direction and circumferential direction of the wheel). As shown in FIG. 6 and FIG. 14, when the fixing component 40 is a screw, the fixing component 40 may be inserted into a fixing hole 122 of the fixing portion 120 in the axial direction, such that the tire and the rim can be fixed together at least in the radial direction. For another example, as shown in FIG. 33 to FIG. 36, when the fixing component 40 is a buckle, the fixing component 40 has a long locking end 420 and a short locking end 430. The long locking end 420 is inserted into the fixing hole 122 of the fixing portion 120 in the axial direction, and the short locking end 430 is inserted into a fixing groove 124 of the fixing portion 120 in the axial direction, such that the tire and the rim can be fixed together at least in the radial direction.

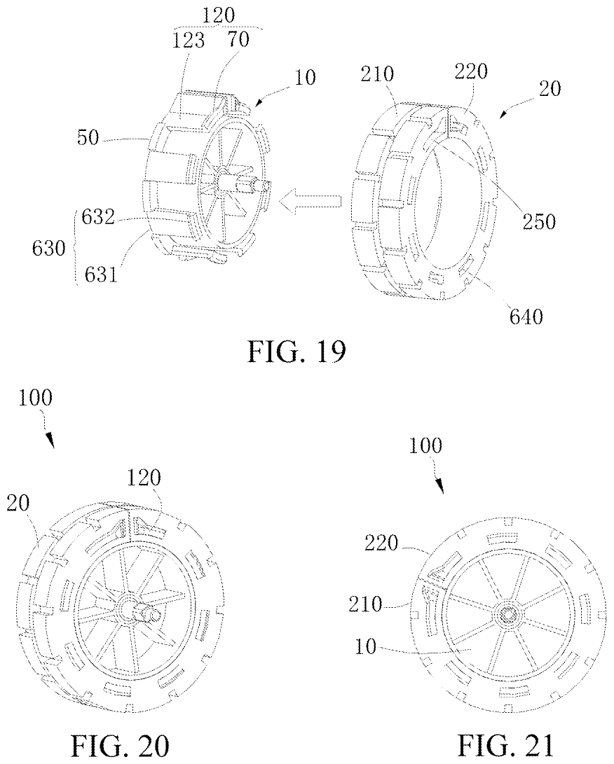

Certainly, when no fixing component 40 is used, that is, when the first end 210 and the second end 220 are connected to the fixing portion 120 without any fixing component, for example, plug-in components 123 and connecting holes 250 in FIG. 19 and FIG. 24 may also lock the tire and the rim, and thus, the plug-in components and the connecting holes may also be referred to as locking mechanisms. The plug-in components 123 are inserted into the connecting holes 250 in the axial direction, such that the tire and the rim may also be locked in the radial direction, and then are fixed together. For another example, as shown in FIG. 30 to FIG. 32, a fixing hole 122 and a connecting screw 223 of the fixing portion 120 may also lock the tire and the rim, and in this case, the fixing hole 122 and the connecting screw 223 of the fixing portion 120 may also be referred to as locking mechanisms. The connecting screw 223 is inserted into the fixing hole 122 in the radial direction, such that the tire and the rim can be locked at least in the circumferential direction. From the above embodiments, it can be understood that the tire and the rim may also at least have a detachable locking mechanism, which can be used for fixing the tire and the rim together in at least one direction. Further, the locking mechanism can be used for fixing the tire and the rim together at least in the radial direction.

In other embodiments, the tire 20 may include a plurality of segments of assembly parts sequentially connected in an end-to-end manner. The first end 210 and the second end 220 are butt-joined ends of two adjacent assembly parts respectively. When the tire 20 needs to be replaced, the tire 20 is disconnected from a butt-joint position of the first end 210 and the second end 220, and then, force is applied from the disconnected position, such that the tire 20 is gradually separated from the rim 10 in the axial direction, which allows the user to independently replace the tire 20 without detaching the body 11.

Considering that the more segments the tire has, the greater the assembly complexity becomes, which on the one hand, is unfavorable for assembly and on the other hand, makes components to be assembled increased, a structure at a joint corresponding to the rim and the tire more complex, and cost increased during wheel assembly, it is not advisable to arrange too many segments in the tire. In an embodiment, the number of segments of assembly parts of the tire is less than or equal to 4; and further, the number of segments of assembly parts of the tire is less than or equal to 3.

It should be noted that, when the tire includes a plurality of segments, lengths of unfolded assembly parts (referred to as length) may be not equal.

Illustratively, the tire 20 may include at least two assembly components, and the adjacent assembly components are connected detachably. When the tire 20 needs to be replaced, it is only necessary to detach one of assembly components. For example, the tire 20 includes a first assembly component and a second assembly component. The length of the first assembly component is ¾ of a circumference defined by the tire 20. The length of the second assembly component is ¼ of a circumference defined by the tire 20. When the tire 20 needs to be replaced, a joint of the second assembly component and the first assembly component is rotated to be exposed outside the body 11, thereby conveniently detaching the second assembly component.

When the entire wheel 100 is exposed outside the body 11, the above solution can be similarly adopted. For example, by rotating the positions where the first end 210 and the second end 220 are located to face away from the body 11, the tire 20 can be conveniently disconnected at the first end 210 and the second end 220, such that the user can independently replace the tire 20.

In order to prevent the tire 20 from moving in the circumferential direction of the rim 10 in the working process of the wheel 100, the wheel 100 further includes a first limiting mechanism. The first limiting mechanism may include two portions configured to engage with each other and respectively arranged on the rim 10 and the tire 20. One of the rim 10 and the tire 20 is provided with a convex portion, and the other one of the rim and the tire is provided with a concave portion. In order to prevent the tire 20 from moving in the axial direction of the rim 10 in the working process of the wheel 100, the wheel 100 further includes a second limiting mechanism. The second limiting mechanism may include two portions configured to engage with each other and respectively arranged on the rim 10 and the tire 20. One of the rim 10 and the tire 20 is provided with a convex portion, and the other one of the rim and the tire is provided with a concave portion.

In other embodiments, the first limiting mechanism or the second limiting mechanism may be arranged on the rim 10 and/or the tire 20. For example, the first limiting mechanism or the second limiting mechanism is a friction region with high friction force. Through friction between the friction region and the rim 10 or the tire 20, or friction of the two friction regions, the purpose of limiting the movement of the tire 20 relative to the rim 10 in the circumferential direction of the wheel 100 is achieved. In this case, the second limiting mechanism and the first limiting mechanism may be used in common, or may be of the same structure, which has the function of limiting the movement of the tire 20 relative to the rim 10 both in the circumferential direction and the axial direction.

The wheel 100 of the present disclosure is further described in conjunction with different embodiments below, such that independent replacement of the tire 20 can be conveniently achieved.

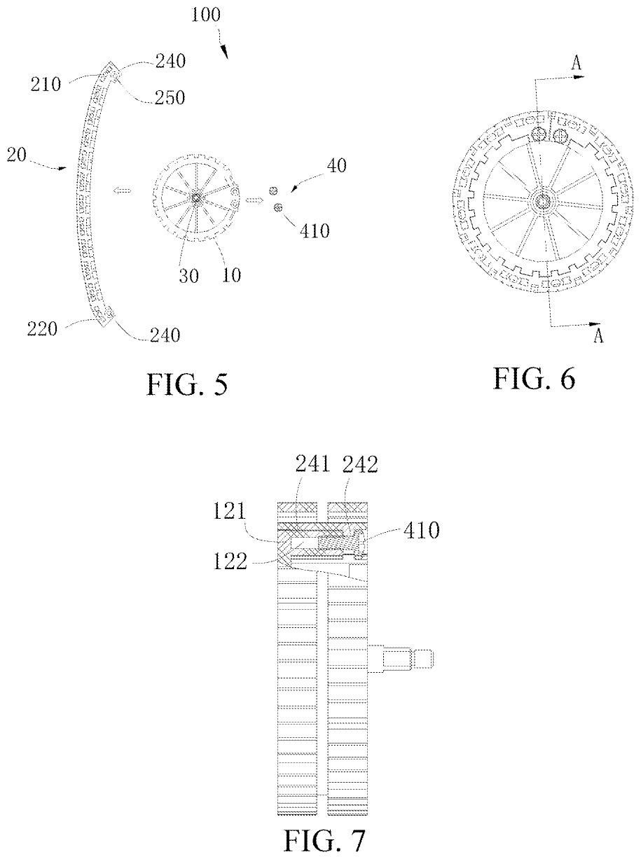

As shown in FIG. 5 to FIG. 10, by combining FIG. 2 to FIG. 4, a wheel 100 in an embodiment of the present disclosure includes a rim 10, and a tire 20 detachably connected to the rim 10. The tire 20 is made of elastic materials. The rim 10 is connected to a wheel axle 30 inward in the axial direction of the wheel 100. The wheel axle 30 is configured to connect to a drive shaft of a walking motor. The tire 20 may be unfolded into a strip shape before being connected to the rim 10. To facilitate description in the following embodiments of the present disclosure, two sides of the wheel 100 in the axial direction are defined as an inner side and an outer side respectively, and the inner side is the side on which the wheel axle 30 is arranged. Correspondingly, when a component refers to terms such as “inner end” and “outer end”, “inner end” refers to the end of the component located on the wheel 100 or close to the inner side of the wheel 100, while “outer end” refers to the end of the component located on the wheel 100 or close to the outer side of the wheel 100. In addition, it should be understood that when the tire 20 is connected to the rim 10, the directions indicated by the circumferential direction of the wheel 100, the circumferential direction of the rim 10, and the circumferential direction of the tire 20 are consistent; and the directions indicated by the axial direction of the wheel 100, the axial direction of the rim 10, and the axial direction of the tire 20 are consistent.

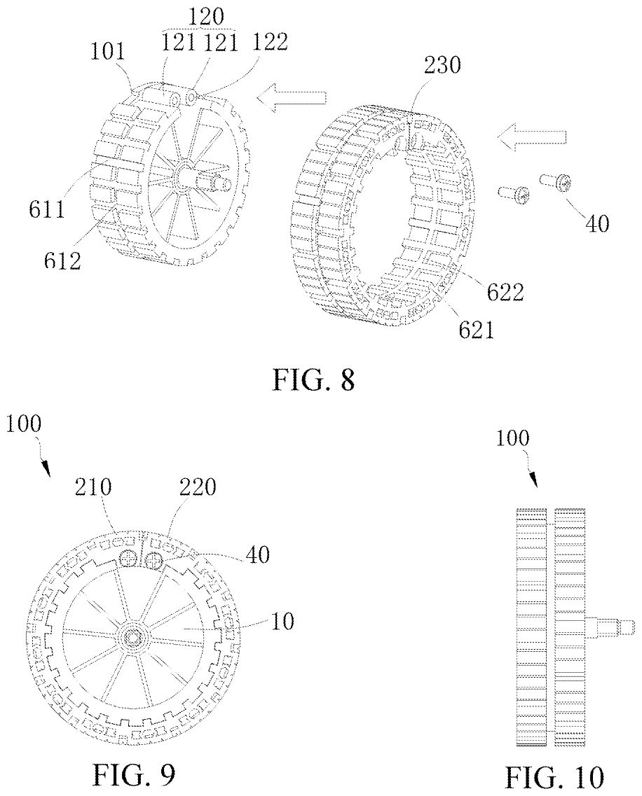

As shown in FIG. 8, an outer circumferential surface 110 of a rim 10 is provided with a fixing portion 120. In this embodiment, the fixing portion 120 includes two fixing columns 121 arranged side by side in the circumferential direction of two wheels 100. A fixing hole 122 is arranged in an inner side of each of the fixing columns 121. The length of the fixing column 121 is slightly smaller than the width of the rim 10 in the axial direction of the rim 10.

As shown in FIG. 5, the tire 20 includes a first end 210 and a second end 220 which are oppositely arranged. The first end 210 and the second end 220 are each provided with a connecting portion 240. After the tire 20 is connected to the rim 10, the first end 210 abuts against the second end 220 in the circumferential direction of the wheel 100. The outer circumferential surface of the tire 20 is continuous and complete, which does not influence the function of the wheel 100.

Referring to FIG. 6 to FIG. 8, the connecting portion 240 includes a groove segment 241 accommodating the fixing column 121, and a clamping segment 242 connected to the groove segment 241. The clamping segment 242 is provided with a connecting hole 250 communicating with the groove segment 241. When the tire 20 is connected to the rim 10, the groove segments 241 accommodate the fixing columns 121, the clamping segments 242 abut against inner ends of the fixing columns 121 in the axial direction, and the connecting holes 250 are aligned with the fixing holes 122 respectively. Then, the fixing component 40 connects the first end 210 and the second end 220 to the fixing portion 120 in the axial direction of the wheel 100. The fixing component 40 is arranged on one side of the wheel 100, specifically, on the inner side. Illustratively, the fixing component 40 includes two screws 410 configured to engage with the fixing holes 122 of the rim 10 respectively. As shown in FIG. 8, one side of the rim 10 located at the inner end of the fixing column 121 is provided with a notch configured to accommodate the clamping segment 242. The outer side of the rim 10 is provided with a series component 101. The two fixing columns 121 are both connected to the series component 101, such that the fixing columns 121 are connected to the remaining part of the rim 10 into a whole through the series component 101, thereby improving reliability of the fixing columns 121.

In addition, after the tire 20 is connected to the rim 10, the series component 101 and the above fixing component 40 are located on the two sides of the tire 20 respectively, thereby axially limiting the tire 20 from the two sides. That is, the fixing component 40 has the functions of connecting the tire 20 and the rim 10 and axially limiting the tire 20. Moreover, the series component 101 also has a certain function of limiting the tire 20 in the axial direction.

In order to prevent the tire 20 from moving in the circumferential direction of the rim 10 in the working process of the wheel 100, the wheel 100 further includes a first limiting mechanism. Illustratively, as shown in FIG. 8, the first limiting mechanism includes a first limiting structure 611 arranged on the outer circumferential surface 110 of the rim 10 and a second limiting structure 621 arranged on the inner side of the tire 20. When the tire 20 is connected to the rim 10, the first limiting structure 611 is engaged with the second limiting structure 621 to limit the movement of the tire 20 relative to the rim 10 in the circumferential direction of the wheel 100.

In this embodiment, the first limiting structure 611 is arranged in the axial direction (width direction) of the rim 10. The first limiting structure 611 includes a plurality of axial grooves formed in the outer circumferential surface of the rim 10 in the circumferential direction of the rim 10. As shown in FIG. 8, the above axial grooves are arranged in two rows in the axial direction of the rim 10. The two rows of axial grooves are arranged side by side in a one-to-one correspondence manner, and may alternatively be arranged in a staggered manner.

The second limiting structure 621 includes a plurality of protruding portions arranged on an inner circumferential surface of the tire 20. The protruding portions are in one-to-one correspondence with the above axial grooves. As shown in FIG. 7 to FIG. 9, when the tire 20 is arranged on the rim 10 in a direction of a hollow arrow in FIG. 8, the tire 20 is connected to the rim 10, the protruding portions are clamped into the axial grooves to limit the movement of the tire 20 relative to the rim 10 in the circumferential direction of the wheel 100. That is, the tire and the rim are detachably connected through a tongue-and-groove engagement mechanism (e.g., a protrusion and a groove).

In order to prevent the tire 20 from moving in the axial direction of the rim 10 in the working process of the wheel 100, the wheel 100 further includes a second limiting mechanism. Illustratively, as shown in FIG. 8, the second limiting mechanism includes a first stop structure 612 arranged on the outer circumferential surface of the rim 10, and a second stop structure 622 arranged on the inner circumferential surface of the tire 20. When the tire 20 is connected to the rim 10, the first stop structure 612 is engaged with the second stop structure 622 to limit the movement of the tire 20 relative to the rim 10 in the axial direction of the wheel 100.

In this embodiment, the first stop structure 612 specifically is a circumferential groove formed in the circumferential direction of the rim 10. The second stop structure 622 is a circumferential protrusion extending in the circumferential direction of the tire 20. As shown in FIG. 7 to FIG. 9, when the tire 20 is arranged on the rim 10 in the direction of the hollow arrow in FIG. 8, the tire 20 is connected to the rim 10, the above circumferential protrusions are clamped into the circumferential grooves. The above circumferential grooves are arranged in a middle position of the rim 10 in the width direction, but the present disclosure is not limited thereto, and the circumferential grooves may be arranged close to one side of the rim 10.

In order to facilitate detachment of the tire 20, the tire 20 is arranged to be elastic, such that when the tire 20 is detached, the tire 20 can deform, thereby easily making the above first limiting mechanism and the second limiting mechanism in failure, and then conveniently detaching the tire 20 from the rim 10. For example, the tire 20 is made of materials with good elasticity. For another example, as shown in FIG. 8, the tire 20 is provided with a through cavity structure in the axial direction of the tire, such that the tire 20 has good elasticity, and the tire 20 is convenient to detach.

When the tire 20 needs to be replaced, by rotating the wheel 100, the first end 210 and the second end 220 of the tire 20 are rotated to be exposed outside the body 11; and then, the screws 410 are dismounted, such that the tire 20 is disconnected at the butt-joint position of the first end 210 and the second end 220. Specifically, starting from the first end 210 or the second end 220, the tire 20 can be gradually separated from the rim 10 in the radial direction, that is, the first limiting structure 611, the second limiting structure 621, the first limiting mechanism, and the second limiting mechanism are all made to be in failure, and then the tire 20 is inwards pulled in the axial direction. After the tire 20 is completely detached from the rim 10, the tire 20 is removed from the position below the body 11 after being unfolded into the strip shape.

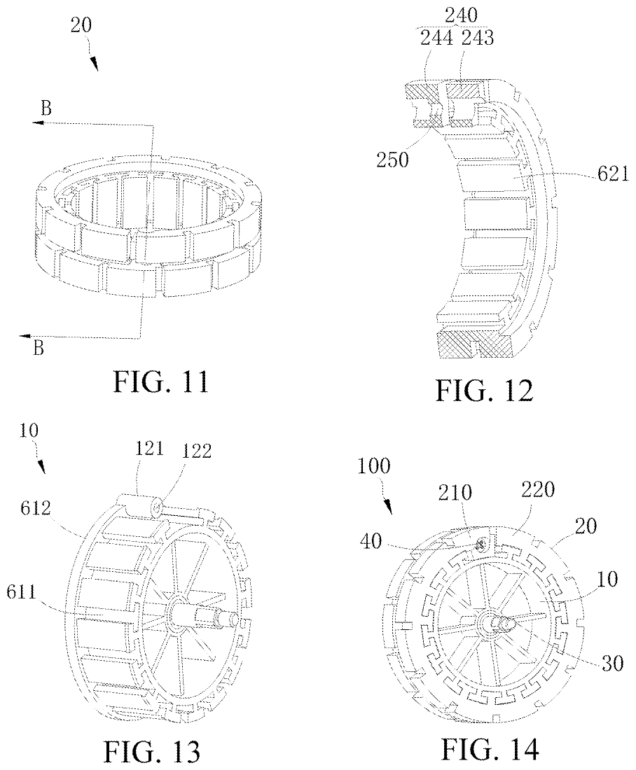

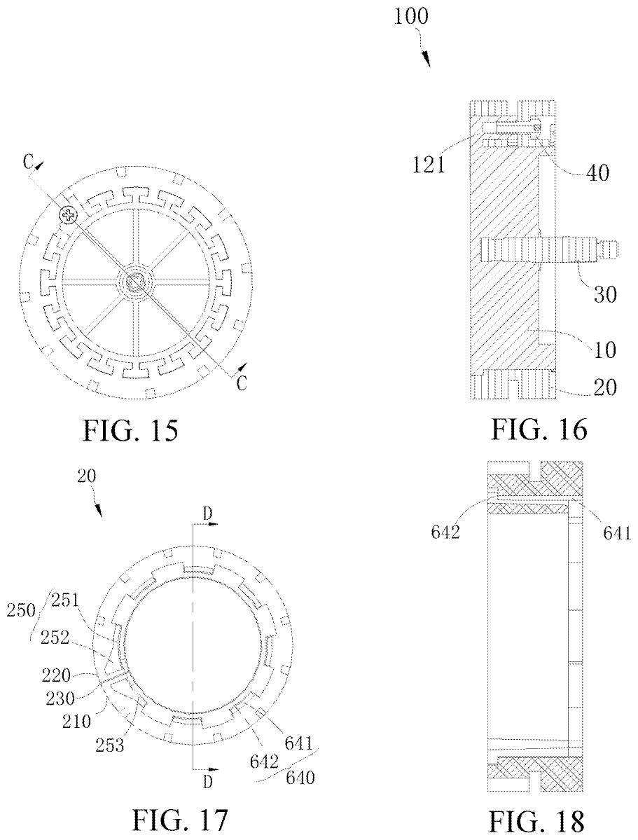

As shown in FIG. 11 to FIG. 16, by combining FIG. 2 to FIG. 4, a wheel 100 in another embodiment of the present disclosure includes a rim 10, a tire 20, and a wheel axle 30 arranged on an inner side of the rim 10. The tire 20 can be unfolded into a strip shape, and includes a first end 210 and a second end 220 which are oppositely arranged.

A fixing portion 120 on an outer circumferential surface 110 of the rim 10 includes a fixing column 121 with a fixing hole 122. As shown in FIG. 12, after the first end 210 and the second end 220 of the tire 20 are butt-joined to form a first connecting portion 243 and a second connecting portion 244. The first connecting portion 243 and the second connecting portion 244 are arranged in the axial direction of the wheel 100. When the tire 20 is connected to the rim 10, the first connecting portion 243 accommodates the fixing column 121, and the second connecting portion 244 abuts against an inner end of the fixing column 121. The second connecting portion 244 is provided with a connecting hole 250, and a screw 410 penetrates through the connecting hole 250 and is connected to the fixing hole 122 of the fixing column 121. In this embodiment, after the first end 210 and the second end 220 of the tire 20 are butt-joined to form a connecting portion 240, and the connecting portion 240 is connected to the fixing portion 120 of the rim 10 through a fixing component 40.

In order to prevent the tire 20 from moving in the circumferential direction of the rim 10 in the working process of the wheel 100, the wheel 100 further includes a first limiting mechanism. The first limiting mechanism further includes a first limiting structure 611 arranged on the outer circumferential surface of the rim 10, and a second limiting structure 621 arranged on the inner circumferential surface of the tire 20. The first limiting structure 611 specifically is a T-shaped groove, and the second limiting structure 621 specifically is a T-shaped protrusion.

In order to prevent the tire 20 from moving in the axial direction of the rim 10 in the working process of the wheel 100, the wheel 100 further includes a second limiting mechanism. The second limiting mechanism is arranged on the inner side of the wheel 100. Specifically, as shown in FIG. 13, the second limiting mechanism includes a first stop structure 612 arranged on the rim 10. Illustratively, the first stop structure 612 is continuously arranged in the circumferential direction of the rim 10. Two ends of the first stop structure 612 are connected to two sides of the fixing column 121 in the circumferential direction of the rim 10 respectively. In addition, there may be a plurality of first stop structures 612 arranged at intervals.

It should be noted that, in this embodiment, the first limiting mechanism and the second limiting mechanism may also adopt the structure shown in FIG. 8, and the specific principle is referred to the relevant description above, which is not repeated herein.

As shown in FIG. 17 to FIG. 21, referring to FIG. 2 to FIG. 4, in another embodiment of the present disclosure, the first end 210 and the second end 220 of the tire 20 are adaptively connected to the fixing portion 120. Specifically, the first end 210 and the second end 220 are both elastically clamped with the fixing portion 120, and the tire 20 and the rim 10 can be connected without using the screws 410. After the tire 20 is connected to the rim 10, the first end 210 abuts against the second end 220 in the circumferential direction of the wheel.

As shown in FIG. 17 and FIG. 18, axial end surfaces of the first end 210 and the second end 220 are provided with the connecting holes 250, and the fixing portions 120 and the connecting holes 250 are in plug-in fit in the axial direction of the wheel 100. The fixing portions 120 match the connecting holes 250 in shape.

Illustratively, the connecting hole 250 includes a first part 251 and a second part 252 which are in communication and are arranged in an L shape. By comparing the second part 252 with the first part 251, the first part 251 may be arranged in the circumferential direction of the wheel 100, while the second part 252 is arranged in the radial direction of the wheel 100 after being bent from one end of a circumferential end face of the first part 251 close to the first end 210 (i.e., an end surface of the first end 210 in the circumferential direction of the wheel 100), such that the second part 252 is closer to the circumferential end surface of the first end 210, and extends towards the outer circumference of the first end 210. Accordingly, the wall thickness of a portion of the tire 20 close to the circumferential end surface of the first end 210 is reduced, thereby improving elasticity of the first end 210, and also facilitating elastic snap fit of the connecting holes 250 and the fixing portions 120. Illustratively, the first part 251 is roughly an arc-shape groove having a certain depth in the axial direction of the wheel 100; and the second part 252 is a triangular groove having a certain depth in the axial direction of the wheel 100. But it should be noted that, the shape of the first part 251 and the second part 252 is not limited to the above description.

When the tire 20 is detached, the first end 210 and the second end 220 are both released from the connecting holes 250 of the rim 10, making the tire 20 disconnected at the first end 210 and the second end 220, thereby facilitating the detachment of the tire 20.

In order to prevent the tire 20 from moving in the circumferential direction of the rim 10 in the working process of the wheel 100, the wheel 100 further includes a first limiting mechanism. In this embodiment, as shown in FIG. 19, the first limiting mechanism includes a plurality of first plug-in structures 630 arranged on the tire 20, and a plurality of second plug-in structures 640 which are arranged on the outer circumferential surface 110 of the rim 10 and are in one-to-one correspondence with the first plug-in structures 630. The first plug-in structures 630 and the second plug-in structures 640 are in plug-in fit in the axial direction of the wheel 100. The plurality of first plug-in structures 630 are arranged on the tire 20 in the circumferential direction of the wheel 100. The plurality of second plug-in structures 640 are arranged on the rim 10 in the circumferential direction of the wheel 100. When the tire 20 is connected to the rim 10, the first plug-in structures 630 are connected to the second plug-in structures 640 in a one-to-one correspondence manner.

In order to prevent the tire 20 from moving in the axial direction of the rim 10 in the working process of the wheel 100, the wheel 100 further includes a second limiting mechanism. As shown in FIG. 19, in this embodiment, the second limiting mechanism includes a first stop structure 612 and a second stop structure 622. The first stop structure 612 is arranged on the outer side of the rim 10 in the axial direction of the wheel 100 to prevent the tire 20 from moving outwards in the axial direction of the wheel 100. The second stop structure 622 is arranged at the inner end of the fixing portion 120 in the axial direction of the wheel 100, to prevent the tire 20 from moving inwards in the axial direction of the wheel 100. A third stop structure 70 is specifically a hook portion. Correspondingly, as shown in FIG. 17, the connecting hole 250 is internally provided with a first step 253 configured to abut against the above hook portion in the axial direction, to prevent the tire 20 from moving inwards in the axial direction of the wheel 100.

After the tire 20 is connected to the rim 10, the fixing portion 120 is clamped into the connecting hole 250; and the fixing portion 120 is tightly wrapped due to elasticity of the tire 20. The first stop structure 612 and the above hook portion respectively limit the tire 20 from the two sides of the tire 20 in the axial direction of the wheel 100.

In this embodiment, when the tire 20 is connected to the rim 10, the tire 20 is in plug-in fit with the rim 10 from the inner side of the rim 10. However, the first stop structure 612 may alternatively be arranged on the inner side of the rim 10, such that the tire 20 is in plug-in fit with the rim 10 from the outer side of the rim 10.

Illustratively, as shown in FIG. 19, the first plug-in structure 630 includes a clamping component 631 arranged on the rim, and a stop portion 632 arranged at an inner end of the clamping component 631 in the axial direction. As shown in FIG. 17, the second plug-in structure 640 includes a slot 641 formed in an axial end surface of the tire 20 and penetrating through the tire 20, and a second step 642 arranged in the slot 641, and the second step 642 is configured to abut against the stop portion 632 in the axial direction. When the clamping component 631 is fixed into the slot 641, the clamping component 631 is engaged with the slot 641 to limit the movement of the tire 20 in the circumferential direction of the rim 10; and meanwhile, the stop portion 632 is connected to the second step 642 to limit the inward movement of the tire 20 in the axial direction.

In this embodiment, the tire 20 is elastic. Specifically, the tire 20 has good elasticity due to the arrangement of the slots 641 and the connecting holes 250. Further, the tire 20 is made of elastic materials.

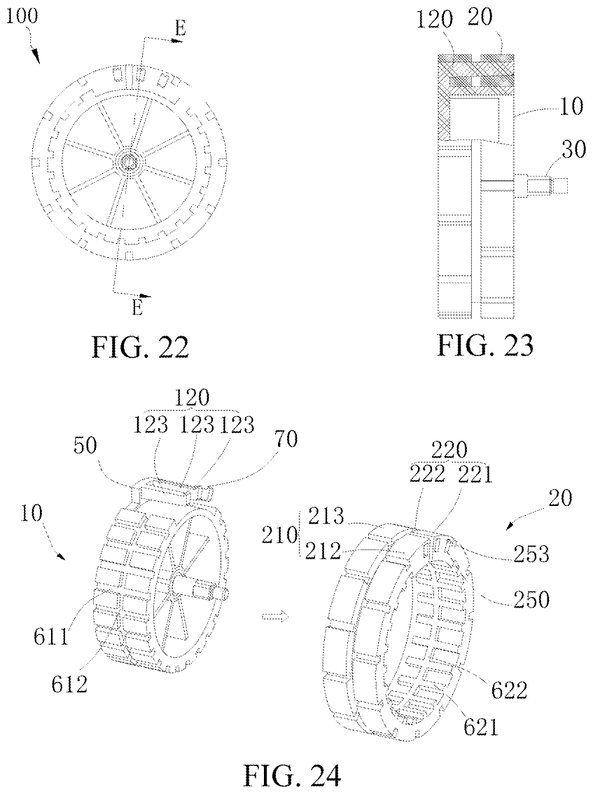

As shown in FIG. 22 to FIG. 25, by combining FIG. 2 to FIG. 4, in another embodiment of the present disclosure, a wheel 100 includes a rim 10, a tire 20, and a wheel axle 30 arranged on the rim 10. The tire 20 can be unfolded into a strip shape, and includes a first end 210 and a second end 220 which are oppositely arranged. The first end 210 abuts against the second end 220 in the circumferential direction of the wheel 100.

A fixing portion 120 of the rim 10 includes a plurality of plug-in components 123 arranged in the circumferential direction of the wheel 100, and the plug-in components 123 are all configured for plug-in connection with the tire 20. Each of the plug-in components 123 is connected to two connecting regions of the tire 20. At least one plug-in component 123 is connected to both the first end 210 and the second end 220. Accordingly, connection of the rim 10 and the tire 20 is firm. In this embodiment, the number of the plug-in components 123 is 3.

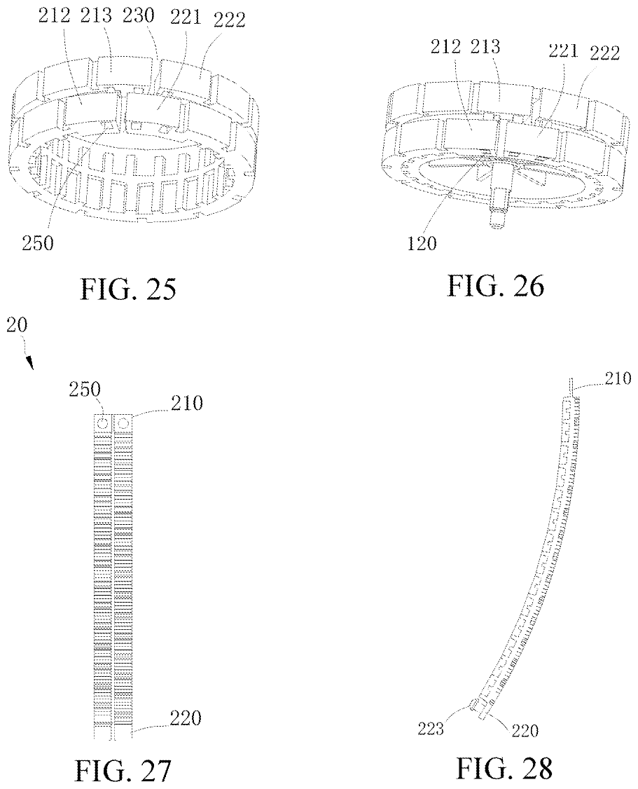

Illustratively, referring to FIG. 24 and FIG. 25, the first end 210 of the tire 20 is provided with a first connecting region 212 and a second connecting region 213 in a spaced manner in the axial direction of the wheel 100. In the circumferential direction of the wheel 100, the first connecting region 212 and the second connecting region 213 are staggered. In the axial direction of the wheel 100, the second end 220 of the tire 20 is provided with a third connecting region 221 and a fourth connecting region 222 in a spaced manner; and in the circumferential direction of the wheel 100, the third connecting region 221 and the fourth connecting region 222 are staggered.

When the tire 20 is connected to the rim 10, as shown in FIG. 25, after the first end 210 and the second end 220 are butt-joined, a joint 230 formed therebetween is in a zigzag shape in the axial direction of the wheel 100. By combining FIG. 24 and FIG. 26, the first connecting region 212 and the second connecting region 213 are connected to the same plug-in component 123 (the plug-in component 123 on the leftmost side on the rim 10 in FIG. 24). The third connecting region 221 and the fourth connecting region 222 are connected to another plug-in component 123 (the plug-in component 123 on the rightmost side in FIG. 24). The second connecting region 213 and the third connecting region 221 are connected to another plug-in component 123 (the plug-in component 123 in the middle in FIG. 24). Accordingly, each of the plug-in components 123 is connected to two regions of the tire 20, making connection of the rim 10 and the tire 20 firm.

In this embodiment, as shown in FIG. 25 and FIG. 26, the first connecting region 212 and the fourth connecting region 222 are each provided with a connecting hole 250. The second connecting region 213 and the third connecting region 221 are each provided with two connecting holes 250 in the circumferential direction of the wheel 100. In the axial direction of the wheel 100, the two connecting holes 250 in the second connecting region 213 are right opposite to the connecting hole 250 of the first connecting region 212 and one connecting hole 250 in the third connecting region 221 respectively. The other connecting hole 250 in the third connecting region 221 is right opposite to the connecting hole 250 in the fourth connecting region 222. Thus, each of the plug-in components 123 can be in plug-in connection with the two connecting holes 250.

In order to prevent the tire 20 from moving in the circumferential direction of the rim 10 in the working process of the wheel 100, the wheel 100 further includes a first limiting mechanism.

Illustratively, the first limiting mechanism in this embodiment is the same as that in the corresponding embodiment in FIG. 8. Specifically, the first limiting mechanism includes a first limiting structure 611 arranged on the outer circumferential surface 110 of the rim 10 and a second limiting structure 621 arranged on the inner side of the tire 20. When the tire 20 is connected to the rim 10, the first limiting structure 611 is engaged with the second limiting structure 621 are to limit the movement of the tire 20 relative to the rim 10 in the circumferential direction of the wheel 100.

In this embodiment, the first limiting structure 611 is arranged in the width direction (axial direction) of the rim 10. The first limiting structure 611 includes a plurality of axial grooves formed in the outer circumferential surface of the rim 10 in the circumferential direction of the rim 10. As shown in FIG. 24, the above axial grooves are arranged in two rows in the axial direction of the rim 10. The two rows of axial grooves are arranged side by side in a one-to-one correspondence manner, and may alternatively be arranged in a staggered manner.

In order to prevent the tire 20 from moving in the axial direction of the rim 10 in the working process of the wheel 100, the wheel 100 further includes a second limiting mechanism. As shown in FIG. 24, in this embodiment, the second limiting mechanism includes a first stop structure 612 and a second stop structure 622. The first stop structure 612 is arranged on the rim 10, and located at an axial outer end of the plug-in component 123. The third stop structure 70 is located at an axial inner end of the plug-in component 123. In addition, the connecting hole 250 is internally provided with a first step 253 which may abut against the above third stop structure 70 in the axial direction. The third stop structure 70 is specifically in a hook shape.

After the plug-in components 123 are in plug-in connection with the connecting holes 250, the plug-in components 123 are fastened in the connecting holes 250 under elasticity of the tire 20. The first stop structure 50 and the third stop structure 70 axially limit the tire 20 from the two sides of the tire 20. It should be understood that the first stop structure 50 may alternatively be arranged at another position of the rim 10, as long as the first stop structure can limit the axial outward movement of the tire 20. The first stop structure 50 may alternatively be arranged to limit the axial inward movement of the tire 20, and the third stop structure 70 is arranged to limit the axial outward movement of the tire 20.

When the tire 20 needs to be independently replaced, by rotating the wheel 100, the first end 210 and the second end 220 of the tire 20 are rotated to be exposed outside the body 11. Then, at least one of the first end 210 and the second end 220 is disconnected from the fixing portion 120, making the tire 20 disconnected at the butt-joint position of the first end 210 and the second end 220, thereby facilitating the detachment of the tire 20. Specifically, the tire 20 can be gradually separated from the rim 10 in the radial direction from the first end 210, such that the first limiting structure 611 is not engaged with the second limiting structure 621, and the plug-in components 123 are separated from the first steps 253 in the connecting holes 250 in the radial direction. Then, the tire 20 is inwards pulled in the axial direction. After the tire 20 is completely detached from the rim 10, the tire 20 is removed from the position below the body 11 after being unfolded into the strip shape.

As shown in FIG. 26 to FIG. 32, by combining FIG. 2 to FIG. 4, in another embodiment of the present disclosure, a wheel 100 includes a rim 10 and a tire 20. The tire 20 can be unfolded into a strip shape, and two opposite free ends of the strip-shaped structure are a first end 210 and a second end 220 respectively. An outer circumferential surface 110 of the rim 10 is provided with a fixing portion 120. When the tire 20 is connected to the rim 10, the first end 210 and the second end 220 are arranged in an overlapping manner on the fixing portion 120.

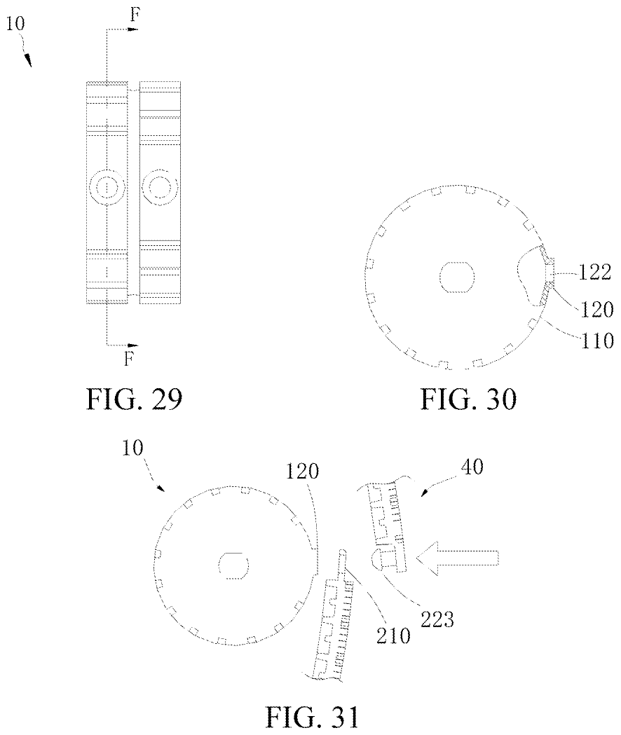

Specifically, as shown in FIG. 26 and FIG. 27, the first end 210 of the tire 20 is provided with a connecting hole 250, and the second end 220 is provided with a connecting screw 223. As shown in FIG. 28 and FIG. 29, the fixing portion 120 of the rim 10 is provided with a fixing hole 122. As shown in FIG. 30 to FIG. 32, when the tire 20 is connected to the rim 10, the first end 210 and the second end 220 are sequentially arranged in an overlapping manner on the fixing portion 120, and the connecting screw 223 at the second end penetrates through the connecting hole 250 in the first end 210 and is inserted into the fixing hole 122 in the fixing portion 120.

When the tire 20 needs to be independently replaced, the second end 220 is detached relative to the rim 10, such that the tire 20 is disconnected at the first end 210 and the second end 220, and then, the entire tire 20 is gradually dismounted.

In order to prevent the tire 20 from moving in the circumferential direction of the rim 10 in the working process of the wheel 100, the wheel 100 further includes a first limiting mechanism. The first limiting mechanism in this embodiment is the same as that in the corresponding embodiment in FIG. 8 or FIG. 13. Specifically, the first limiting mechanism includes a first limiting structure 611 arranged on the outer circumferential surface 110 of the rim 10 and a second limiting structure 621 arranged on the inner side of the tire 20. When the tire 20 is connected to the rim 10, the first limiting structure 611 is engaged with the second limiting structure 621 are to limit the movement of the tire 20 relative to the rim 10 in the circumferential direction of the wheel 100.

In this embodiment, the first limiting structure 611 is arranged in the width direction (axial direction) of the rim 10. The first limiting structure 611 includes a plurality of axial grooves extending in the axial direction of the rim 10 and formed in the outer circumferential surface of the rim 10 in the circumferential direction of the rim 10. As shown in FIG. 24, the above axial grooves are arranged in two rows in the axial direction of the rim 10. The two rows of axial grooves are arranged side by side in a one-to-one correspondence manner, and may alternatively be arranged in a staggered manner.

In order to prevent the tire 20 from moving in the axial direction of the rim 10 in the working process of the wheel 100, the wheel 100 further includes a second limiting mechanism. Illustratively, the second limiting mechanism includes a first stop structure 612 and a second stop structure 622. The inner side of the tire 20 and the outer side of the rim 10 in the axial direction may be provided with the second stop structure and the first stop structure respectively. When the tire 20 is connected to the rim 10, the tire 20 is arranged between the second stop structure and the first stop structure to gradually wind and wrap the rim 10. Meanwhile, the first stop structure 612 is engaged with the second stop structure 622, and the first limiting structure 611 is engaged with the second limiting structure 621. Finally, the first end 210 is first arranged to overlap the fixing portion 120, then, the second end 220 is pressed on the first end 210, and the connecting screw 223 at the second end penetrates through the connecting hole 250 in the first end 210 and is inserted into the fixing hole 122 in the fixing portion 120.

As shown in FIG. 33 to FIG. 36, by combining FIG. 2 to FIG. 4, in another embodiment of the present disclosure, a wheel 100 includes a rim 10 and a tire 20. The tire 20 can be unfolded into a strip shape, and two opposite free ends of the strip-shaped structure are a first end 210 and a second end 220 respectively. When the tire 20 is connected to the rim 10, the first end 210 abuts against the second end 220 in the circumferential direction of the wheel 100.

In this embodiment, as shown in FIG. 36, the first end 210 and the second end 220 of the tire 20 are each provided with a connecting portion 240. Each of the connecting portions 240 is provided with a connecting hole 250. An inner circumferential surface of the rim 10 is provided with a fixing portion 120. Engagement portions configured to engage with the tire 20 and evenly distributed in the circumferential direction may be formed on an outer circumferential surface of the rim 10. A specific structure of the engagement portion is not limited. Thus, the wheel has uniform moving performance in the circumferential direction. The two connecting portions 240 are connected to fixing holes 122 of the fixing portion 120 through a fixing component 40.

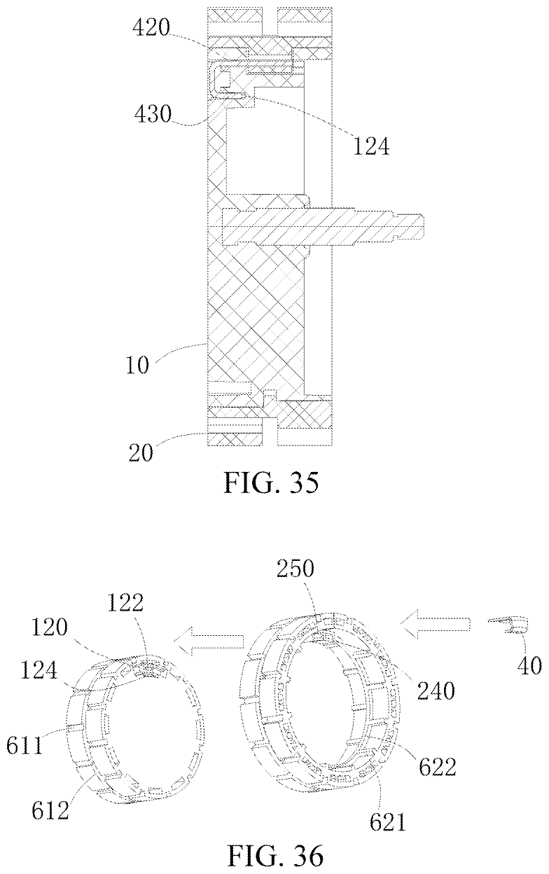

Specifically, as shown in FIG. 35 and FIG. 36, the fixing portion 120 is arranged on the inner circumferential surface of the rim 10. The fixing portion 120 is provided with the two fixing holes 122 in the axial direction of the wheel 100 and two fixing grooves 124 in the axial direction. Each of the connecting portions 240 is provided with a connecting hole 250. The fixing component 40 is a buckle, and includes two long locking ends 420 and two short locking ends 430. When the tire 20 is connected to the rim 10, the two long locking ends 420 penetrate through the connecting holes 250 respectively and are inserted into the fixing holes 122, and the two short locking ends 430 are inserted into the fixing grooves 130. Thus, the tire 20 and the rim 10 are connected together. When the tire 20 is detached, the buckle is removed, such that the tire 20 is disconnected at the first end 210 and the second end 220, thereby detaching the tire 20.

It should be noted that, because the long locking ends are engaged with the fixing holes, the number of the long locking ends may be the same as the number of the fixing holes, for example, when two fixing holes are arranged, two long locking ends are arranged; and certainly, in other embodiments, the number of the long locking ends may be different from the number of the fixing holes, for example, when there is one fixing hole, there may be two long locking ends, as long as cooperation of the fixing hole and the long locking ends can be achieved.

Due to cooperation of the short locking ends and the fixing grooves, in an embodiment, the number of the short locking ends may be the same as the number of the fixing grooves, and accordingly, when one fixing groove is arranged, there may be one short locking end; and certainly, in other embodiments, the number of the short locking ends may be different from the number of the fixing grooves, for example, when there is one fixing groove, there may be two short locking ends, as long as cooperation of the fixing groove and the short locking ends can be achieved.

In order to prevent the tire 20 from moving in the circumferential direction of the rim 10 in the working process of the wheel 100, the wheel 100 further includes a first limiting mechanism. In this embodiment, as shown in FIG. 36, the first limiting mechanism includes a first limiting structure 611 arranged on the outer circumferential surface 110 of the rim 10 and a second limiting structure arranged on the inner side of the tire 20. When the tire 20 is connected to the rim 10, the first limiting structure is engaged with the second limiting structure are to limit the movement of the tire 20 relative to the rim 10 in the circumferential direction of the wheel 100.

Specifically, the first limiting structure 611 includes a plurality of axial grooves formed in the outer circumferential surface of the rim 10 in the circumferential direction of the rim 10. The above axial grooves are arranged in two rows in the axial direction of the rim 10, and the two rows of axial grooves are arranged in a staggered manner. The second limiting structure includes a plurality of protruding portions arranged on the inner circumferential surface of the tire 20. The protruding portions 62 are in one-to-one correspondence with the above axial grooves.

In order to prevent the tire 20 from moving in the circumferential direction of the rim 10 in the working process of the wheel 100, the wheel 100 further includes a second limiting mechanism. Illustratively, as shown in FIG. 36, the second limiting mechanism includes a first stop structure 612 arranged on the outer circumferential surface of the rim 10, and a second stop structure 622 arranged on the inner side of the tire 20. When the tire 20 is connected to the rim 10, the first stop structure 612 is engaged with the second stop structure 622 to limit the movement of the tire 20 relative to the rim 10 in the axial direction of the wheel 100.

In this embodiment, the first stop structure 612 specifically is a circumferential groove formed in the circumferential direction of the rim 10. The second stop structure 622 is a circumferential protrusion extending in the circumferential direction of the tire 20. Referring to FIG. 36, when the tire 20 is arranged on the rim 10 in the direction of a hollow arrow in FIG. 36, the above circumferential protrusions are clamped into the circumferential grooves.

As mentioned above, an engagement portion configured to engage with the tire 20 and evenly distributed in the circumferential direction may be formed on the outer circumferential surface of the rim 10. The engagement portion includes the above first limiting structure 611 and the first stop structure 612. Because there is no need to arrange the fixing portion 120 on the outer circumferential surface of the rim 10, the above first limiting structure 611 and the first stop structure 612 can be evenly distributed in the axial direction of the rim 10, thereby making moving performance of the wheel uniform.

The foregoing embodiments only describe several implementations of the present disclosure, which are described specifically and in detail, but cannot be construed as a limitation to the patent scope of the present disclosure. It should be noted that a plurality of transformations and improvements can also be made by those of ordinary skill in the art without departing from the conception of the present disclosure, which fall within the scope of protection of the present disclosure. Therefore, the protection scope of the patent of the present disclosure shall be subject to the appended claims.

What is claimed is:

1. A moving device comprising:
a body and wheels arranged at a bottom of the body to drive the moving device to move, each of the wheels comprising a rim and a tire,
wherein the tire is detachably connected to the rim and comprises a first end and a second end, the first end and the second end are detachably connected such that the first end and the second end can be disconnected to allow the tire to be detached relative to the rim.

2. The moving device of claim 1, wherein the first end abuts the second end in a circumferential direction of the wheel.

3. The moving device of claim 1, wherein the first end and the second end are arranged in an overlapping manner.

4. The moving device of claim 1, wherein the tire comprises a plurality of segments of assembly parts sequentially connected in an end-to-end manner.

5. The moving device of claim 4, wherein the number of the segments of the assembly parts of the tire is three or less.

6. The moving device of claim 1, wherein the tire and the rim are detachably connected through a tongue-and-groove engagement mechanism.

7. The moving device of claim 1, wherein the wheel comprises a first limiting mechanism configured to limit the relative movement of the rim and the tire in the circumferential direction of the wheel.

8. The moving device of claim 7, wherein the first limiting mechanism comprises a first limiting structure arranged on the rim and a second limiting structure arranged on the tire and configured to engage with the first limiting structure.

9. The moving device of claim 7, wherein the first limiting mechanism comprises a protrusion and a groove configured to engage with each other,
wherein one of the protrusion and the groove is arranged on the rim, and the other one of the protrusion and the groove is arranged on the tire.

10. The moving device of claim 1, wherein the wheel comprises a second limiting mechanism configured to limit the relative movement of the rim and the tire in an axial direction of the wheel.

11. The moving device of claim 10, wherein the second limiting mechanism comprises a first stop structure arranged on the rim and a second stop structure arranged on the tire and configured to engage with the first stop structure.

12. The moving device of claim 1, wherein the tire comprises an elastic material.

13. The moving device of claim 1, wherein the body comprises a housing arranged on an outer side of the wheel and in a projection plane perpendicular to the axial direction of the wheel, a projection contour of the housing partially overlaps with a projection contour of the wheel.

14. The moving device of claim 13, wherein in the axial direction of the wheel a distance between the housing and an outer side of the wheel is less than a width of the wheel in the axial direction of the wheel.

15. The moving device of claim 1, wherein the wheel comprises a locking mechanism that is configured to fix the tire and the rim in at least one direction, whereby the at least one direction comprises at least one of the following: the axial direction, a radial direction and the circumferential direction of the wheel.

16. The moving device of claim 15, wherein the locking mechanism is configured to fix the tire and the rim together in at least the radial direction of the wheel.

17. The moving device of claim 1, wherein the rim comprises a fixing portion and the tire comprises a connecting portion, wherein the connecting portion and the fixing portion are adaptively connected or the connecting portion is detachably connected to the fixing portion through a fixing component.

18. The moving device of claim 17, wherein the fixing portion is arranged on an inner circumferential surface of the rim, and an engagement portion configured to engage with the tire and be evenly distributed in the circumferential direction of the wheel is formed on an outer circumferential surface of the rim.

19. The moving device of claim 17, wherein the fixing component comprises a buckle.

20. The moving device of claim 1, wherein the moving device is a self-moving device, and the self-moving device comprises a robot cleaner.
